(19) United States
(12) Patent Application Publication
(10) Pub. No.: US 2014/0019196 A1
(43) Pub. Date: Jan. 16, 2014

(54) SOFTWARE PROGRAM THAT IDENTIFIES RISKS ON TECHNICAL DEVELOPMENT PROGRAMS

(71) Applicant: Sysenex, Inc., Reston, VA (US)

(72) Inventors: LAURIE WIGGINS, Reston, VA (US); DAVID HALL, Toney, AL (US)

(21) Appl. No.: 13/936,809

(22) Filed: Jul. 8, 2013

Related U.S. Application Data
(60) Provisional application No. 61/669,328, filed on Jul. 9, 2012.

(51) Int. Cl. G06Q 10/06

(52) U.S. Cl. CPC G06Q 10/0635
USPC 705/7.28

(57) ABSTRACT

The disclosed system relates to identification of risk before and during the creation of hardware and software products and services. A method for assessing risk in product development includes the steps of creating a software program and storing the software program in a non-transitory medium, receiving user input respecting the product development program, identifying risks to continuing development of the product, and assigning a technology readiness level to the new technology being incorporated into the product. User input includes query functions and data display capabilities.

The present application is a non-provisional application of and claims priority to U.S. Provisional Patent Application No. 61/669,328, the entire contents of which are hereby incorporated by reference.

### FIELD

The present system relates to identification of risk before and during the creation of hardware and software products and services.

### BACKGROUND

In the insurance and business risk areas, there is a standard approach to risk. There is a list of items that are considered and there are standard ways of identifying and quantifying risk. Previously, there has not been an analogous approach in the product development area, especially for complex and expensive products and products that require high reliability (e.g. aerospace products or medical devices). No currently available risk analysis system performs risk identification as disclosed herein. Rather, the risk systems that are now on the market require a predetermined list of risks before a risk analysis can be conducted, i.e., risks already identified must be provided to the system. Currently, program risk identification is performed manually and suffers from the lack of a thorough or complete approach. Current methods of risk identification include brainstorming, experience from previous programs, development of failure scenarios, or examination of the program work plan. Further, manual risk identification is subject to bias even by very experienced and knowledgeable personnel. Given the increasing complexity of products, a better way has to be found to identify program risk.

The state of the general risk analysis art is shown in various documents. U.S. Pat. No. 8,195,546 (entitled “Methods and systems for risk evaluation”), U.S. Pat. No. 8,135,605 (entitled “Application Risk and Control Assessment Tool”), U.S. Pat. No. 8,050,993 (entitled “Semi-quantitative Risk Analysis”), U.S. Patent Application Publication No. 2011/0282710 (entitled “Enterprise Risk Analysis System”), and U.S. Patent Application Publication No. 2010/0205042 (entitled “Integrated Risk Management Process”). These methods disclose risk analysis but are directed toward managing risk in business and/or financial operations.

Current methods of identifying and evaluating risk are manual—they involve brainstorming, experience from previous programs, development of failure scenarios, or examination of the program work plan. U.S. Pat. No. 8,150,717 (entitled “Automated Risk Assessments Using a Contextual Data Model That Correlates Physical and Logical Assets”), U.S. Pat. No. 8,010,398 (entitled “System for Managing Risk”), U.S. Patent Application Publication No. 2011/0137703 (entitled “Method and System for Dynamic Probabilistic Risk Assessment”), and U.S. Patent Application Publication No. 2010/0063936 (entitled “Method and System for Evaluating Risk Mitigation Plan”).

### SUMMARY

Risks resolved early in a project prevent problems from occurring, thus avoiding the time and money required to fix them. Cost avoidance can be dramatic: the cost of fixing software or hardware problems before the product is built can save 30-100 times the cost incurred later in development. The presently disclosed system efficiently and expediently identifies risks in a project and evaluates their potential effect on a project. No other currently available systems do so.

Based on program specific inputs, the disclosed system will ascertain program risks using a combination of techniques. The system will ascertain likelihood and severity of the identified risks, and will also provide a weighted risk score. The outputs include the list of risks, their likelihood, severity and score. It is notable that this risk program can be used for many types of products and services.

The present system provides an objective, comprehensive approach to risk identification and management. It helps Users address many program areas any one of which could be overlooked by a manual approach. It also will help assess overall program risk by weighing cumulatively a number of factors dispassionately. So it helps identify risks potentially overlooked and it assists Users in understanding the program risk profile overall that may not be evident to program personnel who are involved with a project. Two types of risks are identified and assessed by the present system: 1) individual risks, which are ascertained via a User's answers to questions and 2) overall risk to the program/product posed by the assessment of the individual risks.

Disclosed in the present application is a system and method for assessing risk in hardware and software product and service development. The method includes the steps of creating a software program and fixing the software program in a non-transitory medium, receiving user input respecting the software program, and identifying risks to continuing development of the products and services. The analytical method used to identify the risk is one of a checklist analysis, a Bayesian network analysis, process flow analysis, and a cause and effect analysis. User input includes query functions and data display capabilities.

Risk identification with respect to continuing development of products and services can be dynamically created and updated. As such, the risks are not necessarily selected from a look up table as in prior risk analysis methods. Rather, heretofore unknown risks are identified based on the responses to user queries. The present system/tool extrapolates the data collected from users as far into the future as possible to predict problems before they occur. Further, the more developed the product or service is, the greater the possibility that the present system/tool can use both extrapolation methods and the developing product or service itself to identify risks and assess their threat to the developing product or service.

Each risk is analyzed to determine likely manner of future occurrence and to determine the impact on program cost and schedule if the risk is realized. Each identified risk is ranked with respect to the other identified risks and displayed to the user. The maturity level of new technology incorporated into the product or service is continually monitored and ranked using Technology Readiness levels, which are recognized by the United States Government. The maturity level of the product development effort overall is evaluated by a series of parameters utilized by the system.

The intent with respect to the technology readiness levels is to evaluate the infusion of any new technology into the program. This is separate and distinct from a program that uses existing elements to create a new product. Past research and experience shows that programs that incorporate new technology (as opposed to using exclusively existing elements) is an additional source of risk to the program. How much of an additional risk is subject to evaluation by the system.

Knowing the maturity of the product development effort is beneficial because certain activities will need to have taken place before certain developmental milestones are reached, for example product/testing. Otherwise, the developmental effort is going to be at a higher risk.

If desired, risk identification is looped to continuously provide feedback regarding the status of the product's development. The likely manner of occurrence of future risk can be continually determined in view of the success of avoiding past risk. The identification loop can be done at predetermined intervals or benchmarks. Such benchmarks can be, for example, the development of the product to a certain point where a certain percentage of earlier identified risks are no longer possible to occur.

Any of the above-identified steps can be carried out through appropriate means. For example, a means for creating a software program and for receiving user input is a computer processor. Similarly, the means for ranking a maturity of new technology incorporated into a product can be a look-up table containing government recognized levels of technology readiness.

### BRIEF DESCRIPTION OF THE DRAWING

FIG. 1 is attached drawing is a flowchart showing operation of the current system;

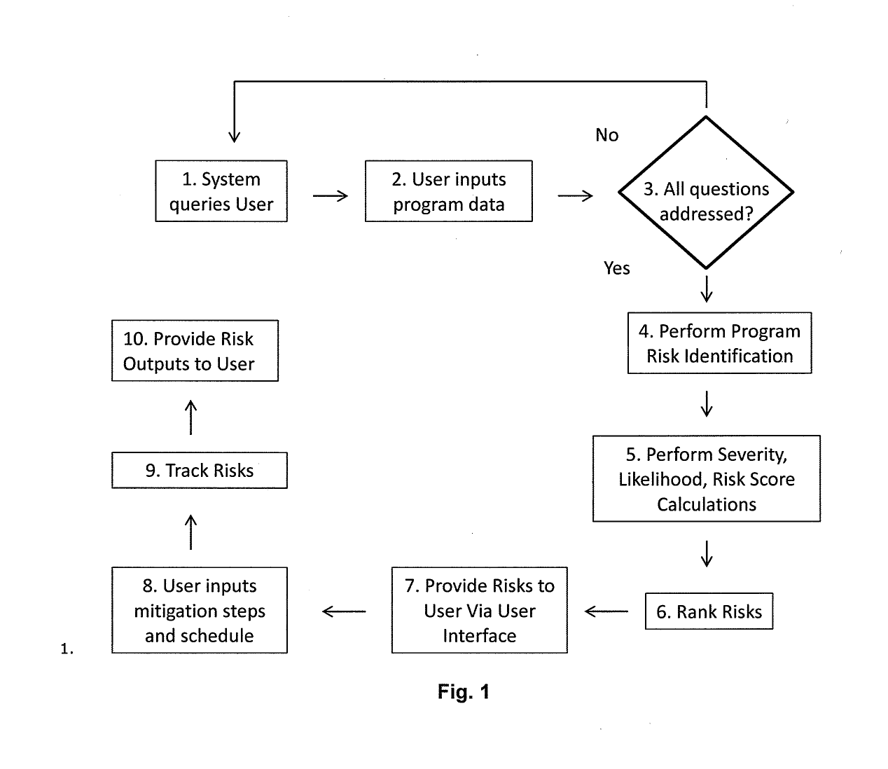

FIG. 2 is a table delineating risk levels; and

FIG. 3 is a table providing notes and suggestions for risk assessment based on a specific organization of concern.

### DETAILED DESCRIPTION

The disclosed Project Risk Management Device (PRMD) is a system that provides a comprehensive and standardized approach to risk management for product development, especially for complex and expensive products and products that require high reliability. The PRMD provides a comprehensive, consistent approach to risk identification. The risks are weighted based on project status. Since project complexity changes the relationship of one risk relative to another, the interplay of the risks is also considered in risk scores.

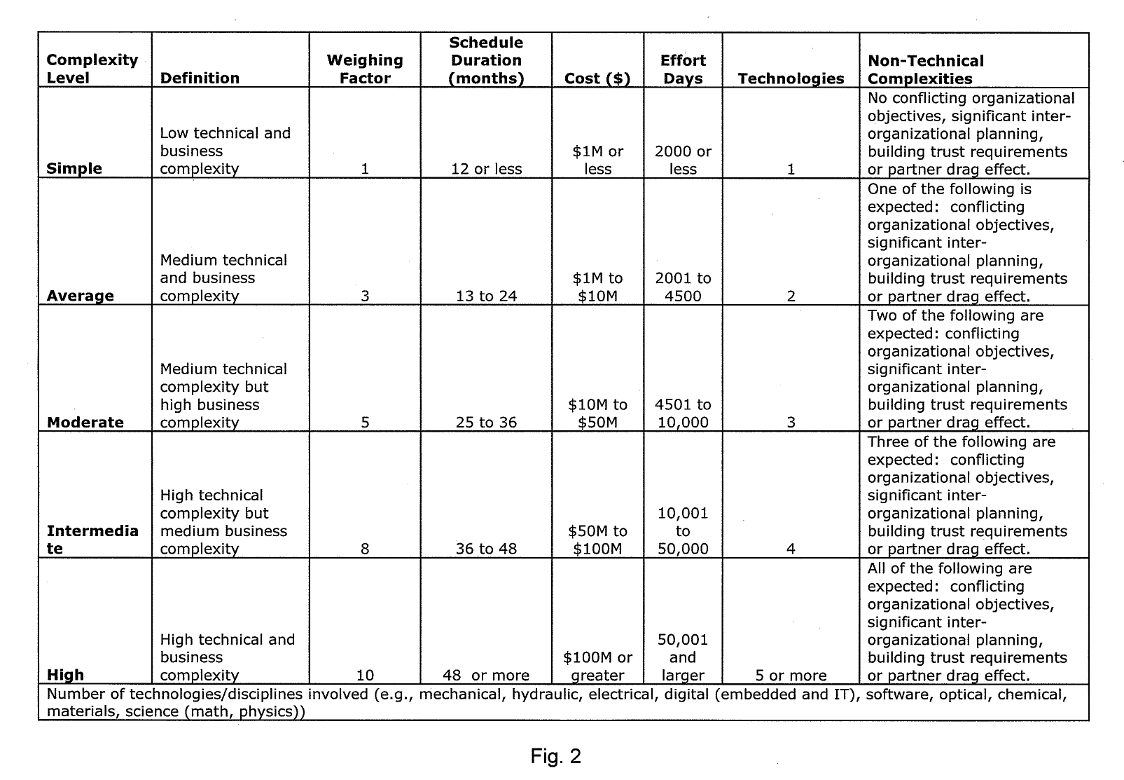

An embodiment of the present system is a system for maintaining a database relating to a project's risk. The system includes a server and a non-transitory medium coupled to the server. The non-transitory medium contains a database. The database contains a table of risks. Two hundred and seventeen potential risks are parsed into six categories: organizational, technical, management, enterprise, operational and external risks. Each risk includes five levels of definition to characterize the seriousness of the risk. Project complexity is based on several factors as shown in FIG. 2 and is included in the risk scores. The system helps a user evaluate project risk by prompting a user to work through all two hundred and seventeen risks or subset thereof and, based on program complexity, the system helps the user figure out what their risks are, and how serious they are.

Organization risk includes but is not necessarily limited to: organizational experience; lessons learned; organizational infrastructure; organizational business/mission benefit; organizational culture; organizational contingency planning; organizational management processes; organizational financial process; organizational critical processes; organizational business process change; organizational interest in personnel motivation; organizational risk management process; organizational risk management process maturity; overall organizational data protection; and overall organizational system protection.

The technical risk category has four subsets: 1) process risk, 2) design factors, 3) Product/Fabrication and 4) test risks. Non-limiting examples of design factors include project requirements definition; project requirements stability; project requirements flowdown; project documentation; quality; safety; interface definition and control; productivity; technology maturity; design maturity; concurrency; common weakness analysis; failure analysis; trade studies; data quality; data conversion; models and simulations; prototypes; development and implementation support resources; personnel training; metrics; user interaction; customer interaction; software complexity (cyclomatic complexity); software development; software integration; software module reliability and quality; experience required to implement software module; software development personnel; software data requirements; software integration maturity; hardware module reliability and quality; experience required to implement hardware module; hardware development personnel; hardware data requirements; hardware integration maturity; hardware capability; systems integration; integration environment and resources; system definition and validation; sensitivity of technology/design to threat; potential for operational failure; potential for human error; facilities/sites; transportation complexity; logistics supportability; and external dependencies.

Process risk includes but is not limited to: critical processes; software methodology and process maturity; hardware methodology and process maturity; parts, material and processes; obsolescence management process; software development best practices; hardware configuration management; software configuration management; change management process; and root cause analysis process.

Production/fabrication risks include but are not limited to: manufacturing readiness; fabrication processes; producibility; material; acquisition of items; and inventory. And non-limiting examples of test risk includes: test planning; system test; component/unit/subsystem testing planning; testing planning; component/unit/subsystem testing resources; system testing resources; component/unit/subsystem testing progress; system testing progress; functional testing; testing required to establish functionality; component/unit software performance functionality; component/unit hardware performance functionality; system software performance functionality; system hardware performance functionality; and system performance functionality.

COTS/GOTS/Reuse planning; COTS/GOTS/Reuse availability; COTS/GOTS/Reuse experience; COTS/GOTS/Reuse integration process; COTS/GOTS/Reuse use; COTS/GOTS/Reuse component maturity; COTS/GOTS/Reuse supplier flexibility; reuse readiness; COTS/GOTS/Reuse complexity; COTS/GOTS/Reuse supplier product help; COTS/GOTS/Reuse documentation and training; COTS/GOTS/Reuse product volatility; COTS/GOTS/Reuse component applicability; COTS/GOTS/reuse component quality; COTS/GOTS/Reuse obsolescence management process common mode/cascading failures; and organizational security processes.

Management risks include but are not limited to planning; work breakdown structure; life cycle management method; achievable goals; project scope; resources and commitment; contingency planning; contract requirements; team organization; team size; management experience; overall program/project/operation/activity staffing; staffing plan; personnel experience; roles, responsibilities and authority; expected (or current) program/project/operation/activity specialized personnel turnover rate; current total personnel turnover rate; personnel morale; management interest in personnel motivation; estimating program/project/operation/ activity cost and schedule; cost development; cost maintenance; funding profile; schedule development; schedule maintenance; management processes; mission assurance process; risk management process; risk management process maturity; management process change; coordination; supplier management; subcontractor management; reviews; program/project/operation/activity manager span of control; metrics; measurement; status reporting; and program/project/operation/activity security processes

Enterprise risk includes but is not limited to: enterprise experience; enterprise lessons learned process; enterprise infrastructure; business/mission benefit; Enterprise culture; enterprise contingency planning; enterprise management processes; enterprise financial process; enterprise critical processes; enterprise business process change; enterprise interest in personnel motivation; enterprise reputation; enterprise risk management process; overall enterprise data protection; overall enterprise system protection; enterprise security processes; enterprise financial impact; and common portfolio. Non-limiting examples of operational risk include use/maintenance complexity; deployment locations; user acceptance; user satisfaction; direct threats; system failure contingencies; infrastructure failure; human error; system operational problems; system availability; external dependencies; system supportability; operational security; operational policies; system data protection; obsolescence management process; readiness verification; personnel training/experience; metrics; system configuration management; inventory; functional testing; system security; testing; disposal; available data/documentation; acceptance criteria; system software update; operational risk management process maturity; acceptance testing; financial; profitability; transportation complexity; facilities/sites; health and safety; operational personnel; business data; common-mode/cascading failures; and near miss consideration.

External risk includes but is not limited to program/project/operation/activity; fit to customer organization; current customer personnel turnover rate; customer experience; customer interaction; destination/use environment; funding; regulatory; legal; litigation; political; labor Market; environmental; country stability; and direct threats.

Two types of risks are identified and assessed by the present system: 1) individual risks, which are ascertained via a User's answers to questions and 2) overall risk to the program/product posed by the assessment of the individual risks. User requests for risk assessment come through a user interface to the server. A user component is contained either within the system on the non-transitory medium or fixedly coupled to a component that is externally coupled to the system. Each user, therefore, has a personal component that acts like an account, for the user. The account can include one project or many projects that are being analyzed for risk assessment. The user records inputs and risk results for current and future reference. All of the risk analyses for each project are specific to a project and, therefore, preferably maintained on the user component. The system stores all risk data in a database including mitigation steps and schedule. This database will be made available to future users when developing other, unrelated projects. Risk data is provided to the User electronically in a variety of formats.

The system includes a configuration console component to provide administrative functions and security. Depending on sensitivity of the project, i.e., security clearance for government project, trade secret considerations, etc., the user component can be the only non-transitory copy of the risk analyses. Alternatively, however, a central account can be maintained by a user accounts administrator in which data is accessible by any number of users. Accessibility to the central account can be determined by the user or by the accounts administrator.

The administrative functions include an import function, an export function, and a calculate scores function. In some embodiments, the system includes a country logic component to determine a base language for the User. In other embodiments, the system includes a database access component to retrieve country-specific data from a plurality of systems, such as European Office System, Canada Bilingual Office System, United States Advanced Office Systems, Nordic, Asian Pacific Latin America, and others.

The system can include a central server coupled to a plurality of remote client servers. A user can access the server remotely to conduct risk analysis, look up risk history, log a reaction to a risk conclusion, etc. Files can be stored at the User's remote location or at the central server to provide a cloud-like experience for the user.

The central server is configured to further to collect data from multiple users and associate the data with one of the risks listed above. Because multiple projects experience similar phenomena, the risks and strategies for overcoming the risks can be compiled and maintained at the central server so that the system is continuously improving itself based on its own experiences through a plurality of users. Of course, the system can be set up to allow a user to opt out of this feature.

Once a User activates the risk program, it begins to query the User for data specific to the product development program of concern to the User. The required data is expressed in the form of questions to the User included in a database as part of the system. The questions can be pre-determined with consecutive questions based on a User's answer to the current question. The User provides answers to all questions asked for by the system. If the User chooses not to answer a question, the system can accept and process this response as well. All answers are stored in a database.

Data required includes specific project data, new technology being developed by the project, and risks already identified by the user/project expressed in a specific format. Once this data is analyzed, additional questions are posed to the User based on the project data. This leads to further analysis as specified in Step 4.

The User provides inputs via the user interface, which includes query functions and data display capabilities. The system continues this process until all questions have been addressed/displayed to the User.

The system identifies project risks. It does this by a variety of methods: including but not limited to Checklist Analysis; Bayesian Network Analysis; Cause and Effect Analysis for known project risks already identified; Process Flow Analysis; and New Technology Maturity Ranking.

Once the risk identification is completed, based on project inputs, the system analyzes each risk for how likely it is to occur, and the impact on project cost and schedule if it occurs. A risk score for each individual risk as well as for the project overall is calculated. The system then ranks the risks with respect to each other.

The risks are displayed to the User via the User Interface along with the severity and likelihood ratings and risk score for each risk, and the overall risk score for the project.

The User inputs mitigation steps and schedule for each risk in specific fields provided in the User Interface. The disclosed system can be configured to evaluate the efficacy of proposed mitigation steps. Of course, if a User uses this system to conduct an additional and unrelated risk analysis, the effectiveness of the mitigation steps can be incorporated into the overall results to track the efficacy of such mitigation steps for future applicability.

### EXAMPLE 1

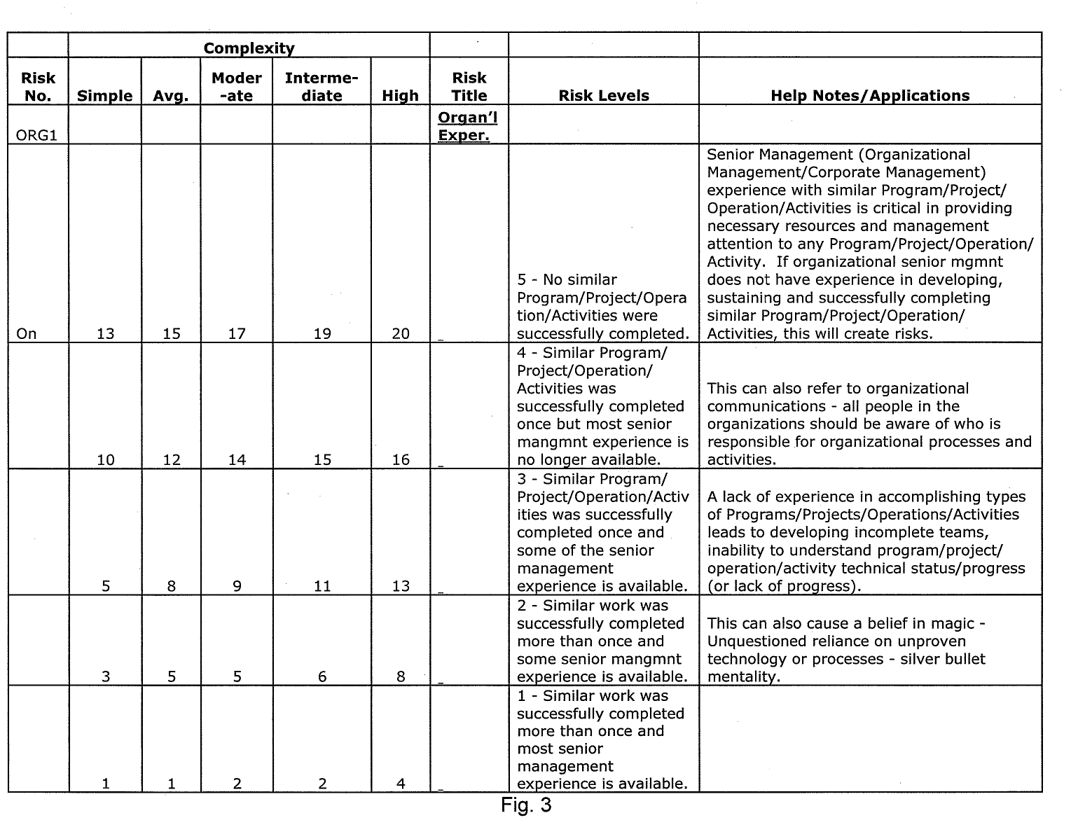

The user will first need to decide on the complexity of their project. They do so by using the table shown in FIG. 2. Once the project complexity has been determined, the user works through each risk. For example, organizational experience, ORG1, is a major factor on many projects. Note the score columns on the left side of the table. The final score for this risk is determined by two things. The user determines the risk level based on the state of the project. The Help Notes/Applications provide additional guidance and in certain cases, additional risk definition. Once the user determines the correct risk level, the system determines the correct score as shown in FIG. 3, which reflects columns that correspond to the previously determined project complexity. The system repeats this process for each risk in a particular category. (Note that users have the option of addressing sub-categories of risks, e.g. only software or hardware items, or only management risks for example.) Risk scores are then calculated for each risk category and compared against low to high scores for each category, and the same for the project risk score (total of all six categories), so that the user knows where they stand.

It is to be understood that the above description is intended to be illustrative and not restrictive. Many other embodiments will be apparent to those of skill in the art upon reviewing the above description, such as adaptations of the present disclosure to integrate additional business systems, or other kinds of business information services. Various designs using hardware, software, and firmware are contemplated by the present disclosure, even though some minor elements would need to change to better support the environments common to such systems and methods. The present disclosure has applicability to various services, computer systems, and user interfaces beyond the example embodiments described. Therefore, the scope of the present disclosure should be determined with reference to the appended claims, along with the full scope of equivalents to which such claims are entitled.

I claim:

1. A method for identifying risk in product development comprising:
creating a software program and fixing the software program in a non-transitory medium;
receiving user input respecting the product development program, and
identifying risks to continuing development of the product using at least one risk analysis method selected from the group consisting of: checklist analysis, Bayesian network analysis, process flow analysis, and cause and effect analysis,
wherein the identification of risks to continuing development of hardware and software products is dynamically created and updated.

2. A method for assessing risk as recited in claim 1 further comprising analyzing each risk to determine likely manner of future occurrence.

3. A method for assessing risk as recited in claim 2 further comprising determining impact on program cost and schedule if risk is realized.

4. A method for assessing risk as recited in claim 3 further comprising ranking the risks with respect to each other.

5. A method for assessing risk as recited in claim 1 further comprising ranking the maturity of new technology utilized in program development using Technology Readiness Levels.

6. A method for assessing risk as recited in claim 5 further comprising looping the risk identification at predetermined intervals of product maturity.

7. A method for assessing risk as recited in claim 5 further comprising determining likely manner of future occurrence based on past realized risk.

8. A method for assessing risk as recited in claim 7 further comprising looping the risk identification at predetermined levels of product maturity.

9. A system for assessing risk in product development comprising
a means for creating a software program in a non-transitory medium;
a means for receiving user input respecting the product development program, and
a means for identifying risks to continuing development of the product using at least one risk analysis method selected from the group consisting of: checklist analysis, Bayesian network analysis, process flow analysis, and cause and effect analysis,
wherein user input includes query functions and data display capabilities.

10. A system for assessing risk as recited in claim 9 further comprising a means for analyzing each risk to determine likely manner of occurrence.

11. A system for assessing risk as recited in claim 10 further comprising a means for determining impact on program cost and schedule if risk is realized.

12. A system for assessing risk as recited in claim 11 further comprising a means for ranking the risks with respect to each other.

13. A system for assessing risk as recited in claim 8 further comprising a means for ranking the maturity of the software program using Technology Readiness Levels.

14. A system for assessing risk as recited in claim 13 further comprising a means for looping the risk identification at predetermined intervals of software maturity.

15. A system for assessing risk as recited in claim 13 further comprising a means for determining likely manner of future occurrence based on past realized risk.

16. A system for assessing risk as recited in claim 15 further comprising a means for looping the risk identification at predetermined levels of software maturity.

17. A method for assessing risk in product development comprising
creating a software program and storing the software program in a non-transitory medium;
receiving user input respecting the product development program, and
identifying risks to continuing development of the product, and
assigning a technology readiness level to the new technology being incorporated into the product;
wherein user input includes query functions and data display capabilities.

18. A method for assessing risk as recited in claim 17 further comprising analyzing each risk to determine likely manner of occurrence.

19. A method for assessing risk as recited in claim 18 further comprising determining impact on program cost and schedule if risk is realized.

20. A method for assessing risk as recited in claim 19 further comprising ranking the risks with respect to each other.
